(19) United States
(12) Patent Application Publication
(10) Pub. No.: US 2022/0266935 A1
(43) Pub. Date: Aug. 25, 2022

(54) TRAILER AXLE STAND

(71) Applicant: Fox Unlimited, LLC, Bostic, NC (US)

(72) Inventor: Chauncey Warren Fox, Bostic, NC (US)

(21) Appl. No.: 17/678,371

(22) Filed: Feb. 23, 2022

Related U.S. Application Data
(60) Provisional application No. 63/152,524, filed on Feb. 23, 2021.

(51) Int. Cl. B62D 63/06; B60S 9/02

(52) U.S. Cl. CPC B62D 63/067; B60S 9/02

(57) ABSTRACT

An axle stand for use with a trailer including a rotatable wheel hub mounted to a distal end of an axle, the wheel hub having a plurality of wheel studs, the axle stand including: a lower component having feet configured to contact soil; an upper component assembled in a sliding fit with the lower component to provide an adjustable height, the upper component having an upper end and a lower end, wherein the upper end defines a saddle including a cutout sized and shaped to receive a central portion of the wheel hub, the saddle further including mounting holes which correspond to a bolt pattern of the wheel studs; and a locking plate configured to be locked to the upper component to prevent access to at least some of the wheel studs.

### BACKGROUND OF THE INVENTION

This invention relates generally to wheeled vehicles and more particularly to trailers for being towed behind motor vehicles.

Electrical generators and other similar support equipment are frequently mounted on single-axle trailers to provide mobility. A trailer-mounted generator can be easily transported to a location where it is needed to provide emergency power. One problem with such trailers is that they represent a high-value asset that is often used in remote locations for extended periods of time, when it is not practical to provide constant security.

Another problem with such trailers is that they typically include means for longitudinal leveling but not for lateral leveling. Complete leveling including lateral leveling is important to ensure proper operation of the equipment. For example, if a trailer is not level, the fuel tank of the internal combustion engine that drives the generator cannot be accurately gauged. Typical operational requirements provide maximum fuel fill levels that must be determined accurately. Furthermore, in an extreme out-of-level condition, the fuel tank could erroneously indicate a full condition for an extended period of time, and then run out suddenly.

### BRIEF SUMMARY OF THE INVENTION

At least one of these problems is addressed by the technology described herein, which provides an adjustable axle stand.

According to one aspect of the technology described herein, an axle stand is described for use with a trailer including a rotatable wheel hub mounted to a distal end of an axle, the wheel hub having a plurality of wheel studs. The axle stand includes: a lower component having feet configured to contact soil; an upper component assembled in a sliding fit with the lower component to provide an adjustable height, the upper component having an upper end and a lower end, wherein the upper end defines a saddle including a cutout sized and shaped to receive a central portion of the wheel hub, the saddle further including mounting holes which correspond to a bolt pattern of the wheel studs; and a locking plate configured to be locked to the upper component to prevent access to at least some of the wheel studs.

### BRIEF DESCRIPTION OF THE DRAWINGS

The invention may be best understood by reference to the following description taken in conjunction with the accompanying drawing figures, in which:

FIG. 1 is a schematic perspective view of an exemplary trailer with a generator mounted thereto;

FIG. 2 is an exploded side elevation view of portion of an axle, hub, and wheel;

FIG. 3 is a view along lines 3-3 of FIG. 2;

FIG. 4 is a schematic exploded perspective view of an exemplary axle stand;

FIG. 5 is a front elevation view of a lower component of the axle stand shown in FIG. 4;

FIG. 6 is a front elevation view of an upper lower component of the axle stand shown in FIG. 4;

FIG. 7 is an enlarged view of a portion of the upper component shown in FIG. 6;

FIG. 8 is a front elevation view of a locking plate shown in FIG. 1; and

FIG. 9 is a side elevation view showing an axle hub of a trailer coupled to the axle stand.

### DETAILED DESCRIPTION OF THE INVENTION

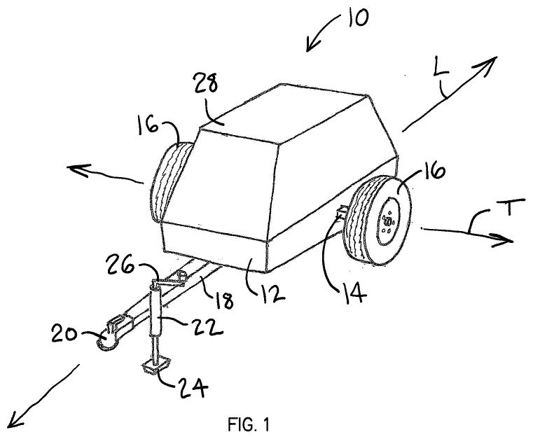

Referring to the drawings wherein identical reference numerals denote the same elements throughout the various views, FIG. 1 illustrates a typical trailer 10 including a chassis 12 supported by an axle 14. Wheels 16 are mounted on the axle 14 and rotate about an axis “T” parallel to a transverse axis of the trailer 10. A tongue 18 extends forward from the chassis 12, parallel to a longitudinal axis “L” of the trailer 10, and terminates in a hitch 20. A ball hitch is shown as an example but a pintle ring is another typical type of hitch. A leveling jack 22 is mounted to the tongue 18 and has a foot 24 which extends or retracts in response to operation of a crank 26. The chassis 12 carries a housing 28 which encloses the payload of the trailer 10. In the illustrated example, the housing 28 could include an electric generator powered by an internal combustion engine.

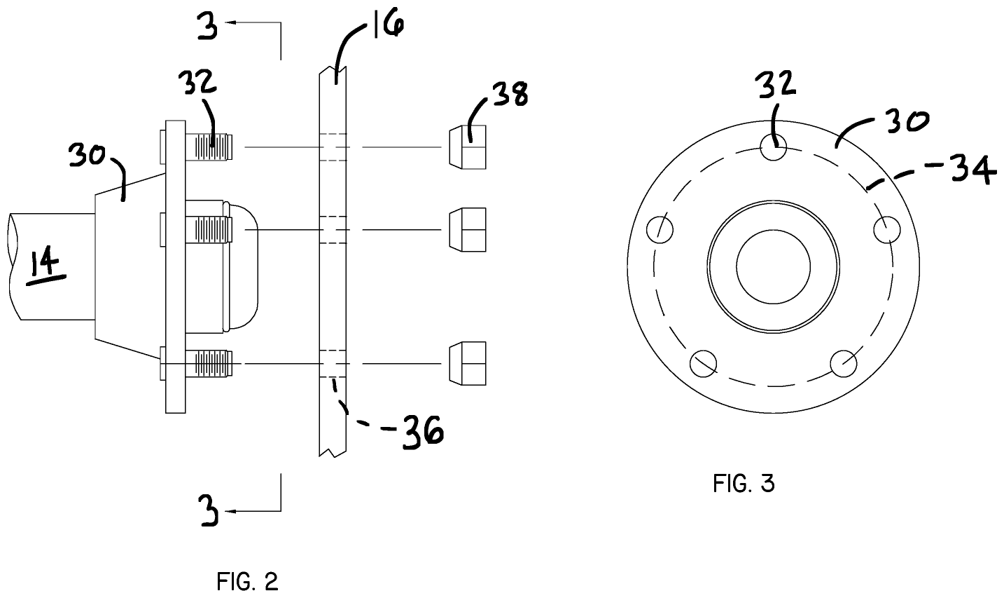

FIG. 2 illustrates how the wheels 16 are mounted to the axle 14 in more detail. Each distal end of the axle 14 terminates in a rotatable hub 30. The hub 30 carries a plurality of pressed-in threaded wheel studs 32. As seen in FIG. 3, these are arranged in a uniform radial array around the centerline axis of the hub 30. The specific arrangement of wheel studs 32 is typically referred to as a “bolt pattern” and is described by the number of studs and the radius of a bolt circle 34. Common examples of bolt patterns include five bolts arranged in a 4.5 inch diameter circle and six bolts arranged in a 5.5 inch diameter circle. The wheel 16 includes bolt holes 36 which match the bolt pattern. The wheel 16 is mounted by placing the bolt holes 36 over the wheel studs 32 and securing it with female threaded lug nuts 38.

Referring again to FIG. 1, it will be understood that certain types of equipment contained in the housing 28 require that the trailer 10 be oriented level or nearly level about the long axis L and the transverse axis T. This may be for example, to provide accurate reliable fuel level gaging, to prevent spillage of fuel, lubricants, or coolant, or to prevent pumps from cavitating dating during operation.

As illustrated, the leveling jack 22 is useful to support the tongue 18 when the trailer 10 is not hitched to a vehicle. It can also be used to level the trailer 10 by rotating it about transverse axis T (i.e. by pitching the tongue 18 up or down). This is referred to as “longitudinal leveling”.

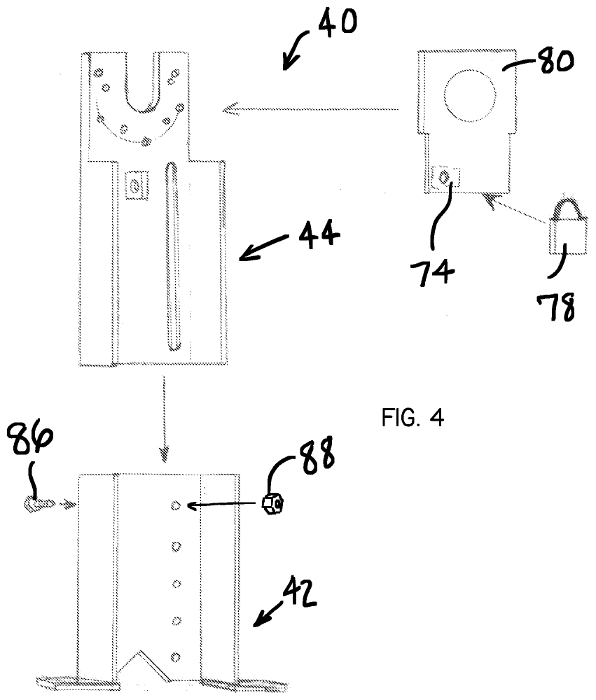

FIG. 4 illustrates an axle stand 40 suitable for use with the trailer 10. The basic parts of the axle stand 40 include a lower component 42, an upper component 44, and a locking plate 80.

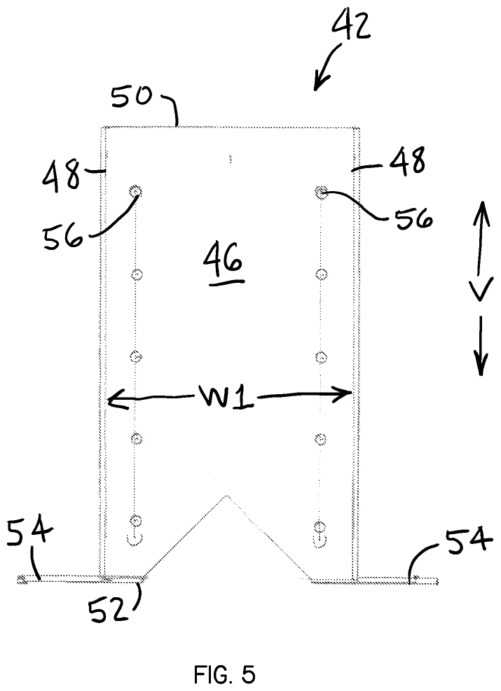

The lower component 42, seen in FIG. 5, is generally a C-shaped channel with a web 46 and flanges 48, extending between upper and lower ends 50, 52. Feet 54 are disposed at the lower end 52 to prevent sinking in soft soil. The lower component 42 may be unitary or may be fabricated smaller pieces. In one example, it may be cut from a length of steel channel stock. It has an overall inside width “W1”. In the illustrated example, it includes two rows of bolt holes 56 spaced at selected intervals in the vertical direction “V”.

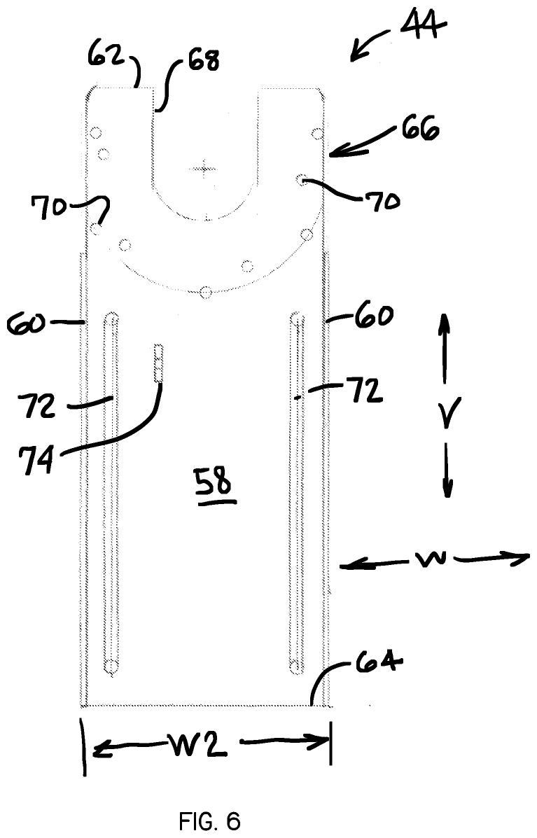

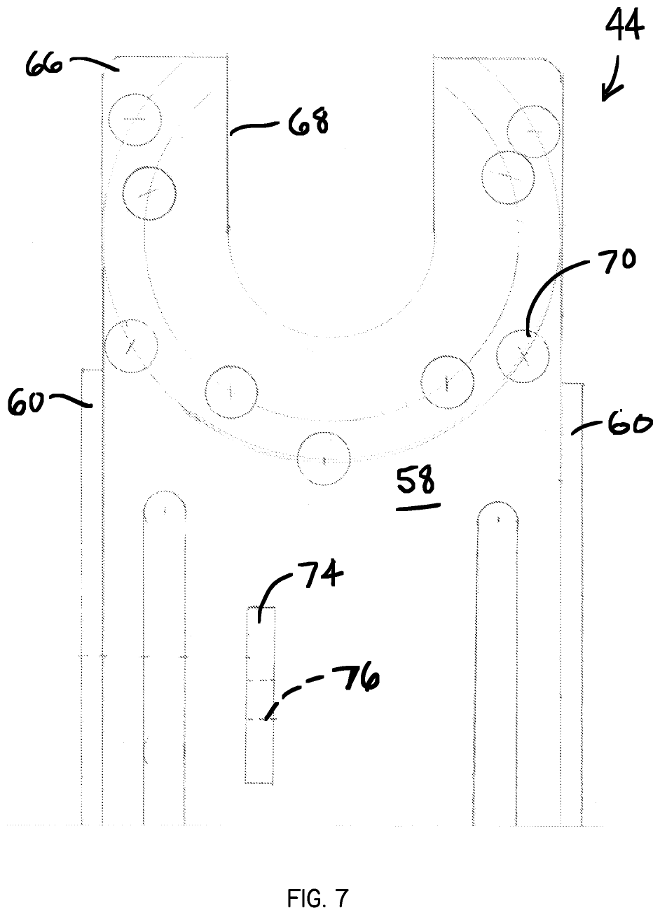

The upper component 44, seen in FIG. 6, is generally a C-shaped channel with a web 58 and flanges 60, extending between upper and lower ends 62, 64. At the upper end 62, the web 58 extends beyond the flanges 60 to define a saddle 66 which includes a cutout 68 sized and shaped to receive the central portion of the wheel hub 30. The saddle 66 includes mounting holes 70 which are arranged to correspond to one or more bolt patterns as described above. In the illustrated example, best seen in FIG. 7, two different bolt patterns (“five on 4.5” and “six on 5.5”) are drilled into the saddle 66.

In the illustrated example, the upper component 44 includes two adjustment slots 72 elongated in the vertical direction “V”. They are spaced in the width direction “W” to align with the rows of bolt holes 56 in the lower component 42.

The upper component 44 has an overall outside with “W2”. This is selected to provide a sliding fit of the upper component 44 in the lower component 42.

Finally, the upper component 44 includes a locking tab 74 protruding from the web 58. The locking tab 74 has a lock hole 76 formed therein which is sized to receive the shackle of a conventional padlock 78 (see FIG. 4).

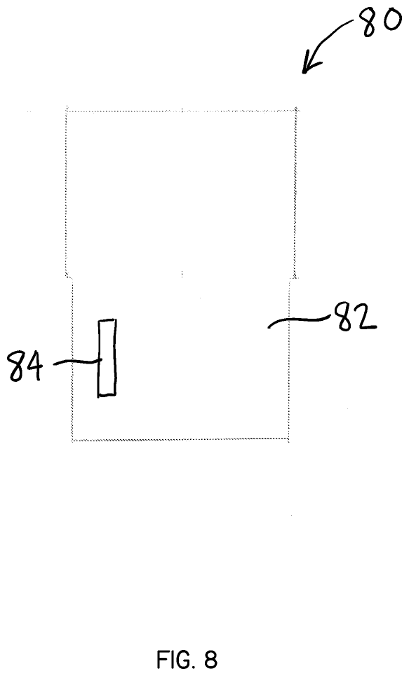

FIG. 8 shows the locking plate 80 which is a solid, generally rectangular component. It has a necked-down bottom portion 82 with a width sized to fit relatively closely between the flanges 60 of the upper component 44. It includes a locking slot 84 sized and shaped to fit over the locking tab 74.

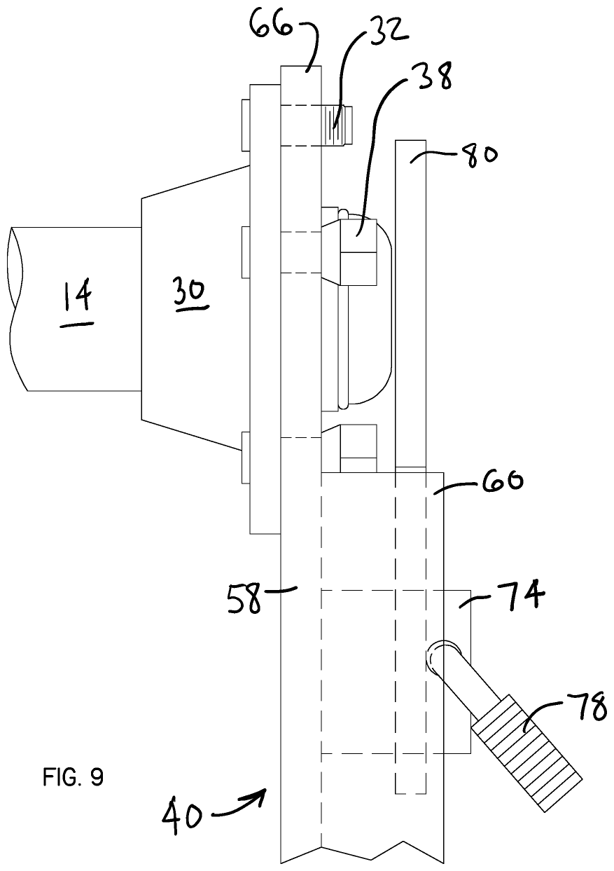

The axle stand 40 is used by, first, transporting the trailer 10 to a desired location. It is then unhitched from the towing vehicle (not shown) and the tongue 18 supported by the leveling jack 22. Taking one wheel 16 at a time, the chassis 12 is supported by a conventional jack (not shown) and the wheel 16 is removed. The axle stand 40 is secured to the hub 30 by placing the saddle 66 over the wheel studs 32 and using the lug nuts 38 to clamp the axle stand 40 to the hub 30 (see FIG. 9). The axle stand 40 is then extended until the feet 54 touch the ground. As part of this process, the trailer 10 is leveled by pivoting it as needed about longitudinal axis L (i.e. rolling it left or right). This is referred to as “lateral leveling”. The upper component 44 and the lower component 42 are then secured together using clamping bolts 86 (FIG. 4) passing through the aligned bolt holes 56 and adjustment slots 72, secured with clamping nuts 88. It will be understood that other specific means may be used to connect the upper component and the lower component and provide a height adjustment. For example, both components could be slotted, or both components could include rows of bolt holes. Optionally, other types of fasteners could be used.

This process is repeated for the other wheel 16. If necessary, the trailer may be re-leveled by adjusting the relative heights of the two axle stands 40 once they are installed.

After installation and leveling is complete, each of the axle stands may be secured by placing the locking plate 80 over the locking tab 74 and locking the two together with a conventional padlock 78. The locking plate 80 covers the wheel studs 32, preventing access to at least some of the wheel studs 32 with a wrench or other tool. To the extent of the wheel studs 32 are accessible, the locking plate 80 is positioned close enough to the wheel studs 32 to prevent the lug nuts 38 from being removed even if a thief should partially unthread them.

Thus installed, the axle stands 40 allow the trailer 10 to be left unattended for extended periods while reducing the risk of it being stolen by simply being towed away.

To move the trailer 10, the process is reversed, removing the locking plates 80 and axle stands 40 and replacing the wheels 16.

The foregoing has described an axle stand and a method for its use. All of the features disclosed in this specification, and/or all of the steps of any method or process so disclosed, may be combined in any combination, except combinations where at least some of such features and/or steps are mutually exclusive.

Each feature disclosed in this specification may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. An axle stand for use with a trailer including a rotatable wheel hub mounted to a distal end of an axle, the wheel hub having a plurality of wheel studs, the axle stand comprising:
a lower component having feet configured to contact soil;
an upper component assembled in a sliding fit with the lower component to provide an adjustable height, the upper component having an upper end and a lower end, wherein the upper end defines a saddle including a cutout sized and shaped to receive a central portion of the wheel hub, the saddle further including mounting holes which correspond to a bolt pattern of the wheel studs; and
a locking plate configured to be locked to the upper component to prevent access to at least some of the wheel studs.
